(19) United States
(12) Patent Application Publication
(10) Pub. No.: US 2010/0140506 A1
(43) Pub. Date: Jun. 10, 2010

(54) METHOD OF DETERMINING A MEASUREMENT VALUE ON THE BASIS OF SINGLE MOLECULE EVENTS

(75) Inventors: Christian EGGELING, Gottingen (DE); Andreas SCHÖNLE, Gottingen (DE); Stefan W. HELL, Gottingen (DE); Michael HILBERT, Jena (DE)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Max-Planck-Gesellschaft zur Forderung der wissenschaften e.V., Munchen (DE)

(21) Appl. No.: 12/687,969

(22) Filed: Jan. 15, 2010

Related U.S. Application Data
(63) Continuation of application No. PCT/EP2008/059222, filed on Jul. 15, 2008.

(30) Foreign Application Priority Data
Jul. 18, 2007 (DE) 10 2007 033 737.1

(51) Int. Cl. G01N 21/64

(52) U.S. Cl. 250/459.1

(57) ABSTRACT

A method of determining a measurement value on the basis of a plurality of single molecule events of marker molecules in a sample comprises the steps of selecting the marker molecules from a group of marker molecules which are transferable between a measurable state in which a measurement signal necessary for determining the at least one measurement value is obtainable from the marker molecules and a non-measurable state, of providing the marker molecules in the sample at such an absolute concentration that the at least one measurement value is not determinable, if all marker molecules are in their measurable state, and adjusting a measurement concentration of the marker molecules in the measurable state by means of applying the physical signal to the sample at such an intensity that the at least one measurement value is determinable within a defined measurement area of the sample.

### CROSS REFERENCE TO RELATED APPLICATIONS

The present application is a continuation of International Application PCT/EP2008/059222 entitled “Method for Determining a Measurement Value based on Single Molecule Events”, filed Jul. 15, 2008, and claims priority to co-pending German Patent Application No. DE 10 2007 033 737.1 entitled “Verfahren zur Bestimmung eines Messwerts auf der Basis von Einzelmolekulereignissen”, filed Jul. 18, 2007.

### FIELD OF THE INVENTION

The present invention relates to a method of determining at least one measurement value on the basis of a plurality of single molecule events of a plurality of marker molecules of a same kind.

### BACKGROUND OF THE INVENTION

The term “marker molecules” refers molecules, like for example fluorescence dyes, by which other molecules, like for example proteins in a cell or partners of a chemical reaction, can be marked to monitor the marked molecules by measurement techniques in which the marker molecules and thus the marked molecules but no unmarked molecules are visible. The term “marker molecules” also refers to molecules, like for example fluorescent proteins (FP), which already include a marker in the previous sense due to their structure and which thus do not need to be marked by a further molecule to be visible in measurement techniques. Further, the term “marker molecules” even refers to complexes including marker molecules, in which the measurement signal depends on the characteristics of the complex, like for example the distance or the relative orientation of its constituents. A typical example for an application of these latter Marker molecules is the investigation of binding behaviour by means of so-called FRET pairs.

The term “measurement value on the basis of single molecule events” refers to a measurement value which bases on the change in state and/or position of single marker molecules. Such a change in state results in a change in the measurement signal which often is of discrete nature. In case of a fluorescence dye used as the marker molecule, however, the change of state does not simply and solely refer to an exitation of a fluorescent state or an return to a ground state of the fluorescence dye upon emission of fluorescence light, and the discrete change of the measurement signal does not refer to the emission of a single photon of the fluorescence light. Instead, in case of a fluorescence dye used as the marker molecule, a plurality of photons of the fluorescence light have to be received as the measurement signal and to monitor changes in this measurement signal.

The indication that “the at least one measurement signal is not determinable on the basis of single molecule events” under certain conditions, has the meaning in this description that it is at least not properly determinable. This, for example, means that it is only determinable on the basis of single molecule events at a very low accuracy under these conditions as compared to proper conditions for this determination.

Quite a few spatial and temporal parameters of molecule distributions may be determined by marking molecules of interest with a fluorescence dye and by analyzing fluorescence light from the fluorescence dye as a measurement signal. Fluorescent light detection is so sensitive that it even allows for the detection of single molecules. Various successful experimental techniques, such as fluorescence correlation spectroscopy (FCS) and fluorescence intensity distribution analysis (FIDA) as well as multi-parameter fluorescence detection (MFD) are based on this effect. An overview over these techniques, which are commonly designated as single molecule fluorescence spectroscopy, is found in C. Eggeling et al.: “Multi-Parameter Fluorescence Detection at the Single-Molecule Level: Techniques and Applications” in 2. BIOSENSOR SYMPOSIUM, Tubingen, Germany, 2001.

The techniques of single molecule fluorescence spectroscopy, however, require that, on the one hand, not too much molecules contribute to the measurement signal at the same time, and, on the other hand, not only one or very few individual molecules contribute to the measurement signal. This corresponds to a very small acceptable concentration range at a very low concentration of the fluorescently marked molecules within or even below the nanomolar concentration range. This precondition has up to now excluded the very promising application of single molecule fluorescence spectroscopy on systems in which higher molecular concentrations, like for example in the micromolar range, are necessarily present. Single molecular event based experiments, like for example FCS, FIDA and other methods of fluorescence fluctuation analysis, can, for example, not be applied to binding reactions with a low affinity, because these reactions require excess concentrations of the possible binding partners with minimum amounts of the binding product, or to enzymatic reactions, because these reactions are generally optimized for high substrate concentrations.

Various attempts have been made to overcome this disadvantage of single molecule fluorescence spectroscopy. These attempts include the reduction of the dimensions of the measurements area to keep the number of fluorescent marker molecules which are simultaneously detected small even at a higher concentration. In the three-dimensional case, this means a reduction of the dimensions of the measurement volume. To this end, the measurement area has been delimited in direct contact with the sample, particularly by means of special near field optics (SNOM, TIRF), by mechanical delimitations of the measurement volume, for example by means of wave guide structures, as well as purely optical, for example by a combination with STED-microscopy, down to below the diffraction barrier. These techniques, however, are associated with limitations to the sample geometry determined by the experiment and/or with a possible corruption of the measurement value. Further, the efforts to be taken for realising these techniques are very high.

In another attempt, only a fraction of the molecules of interest have been marked with the marker molecules. This, however, includes the danger that the marked molecules display a different behaviour with regard to the measurement value of interest than the unmarked molecules, which makes interpretation of the measurement value more complicated. Further, it has to be known prior to the step of marking which percentage of the molecules should be marked to achieve optimum results and how this goal is achieved. In the worst case, a lot of iterations are necessary until the optimum value is actually achieved.

J. Lippincott-Schwartz et al.: “Development and Use of Fluorescent Protein markers in Living Cells” in Science, Vol. 300, Apr. 4, 2003, pp. 87 ff. disclose various methods for monitoring the diffusion and the movement of molecules marked with fluorescent marker molecules. In a method called FRAP (Fluorescence Recovery After Photobleaching) the recovery of the fluorescence in a measurement area of a sample is observed. In this method no measurement value on the basis of single molecule events is obtained but the variation in time of the fluorescence is detected in the observed measurement range. In a further method described by Lippincott-Schwartz et al. which is designated as FLIP (Fluorescence Loss In Photobleaching), the fluorescent marker molecules in the sample are bleached within a bleaching area located outside the actual measurement area. As the fluorescence in the actual measurement area here also decreases due to the diffusion of the marker molecules, it is possible to conclude on the diffusion of the marker molecules or of the molecules marked with the marker molecules. This measurement value is also not based on single molecule events. This also applies to a further method described by Lippincott-Schwartz et al. in which marker molecules not being in a fluorescent state at the beginning are transferred in their fluorescent state within a measurement area by means of an optical signal, and in which a decrease of the fluorescence in the measurement area due to diffusion of the activated marker molecules out of the measurement area is observed. Further, Lippincott-Schwartz et al. describe that the sample may be imaged with a fluorescent light microscope at different points in time after the local activation of the marker molecules in their fluorescent state to determine the diffusion of the fluorescent marker molecules, i.e. to determine their respective spatial distribution. Lippincott-Schwartz et al. also refer to fluorescence correlation spectroscopy (FCS) as a method of localizing and determining the kinetic behaviour of marked proteins. FCS is a method of determining measurement values on the basis of single molecule events. Lippincott-Schwartz et al., however, do not indicate that the described photo-activated proteins could also be used for FCS investigations.

In the past, the kinetics of switchable fluorescence molecules has already been investigated by methods of single molecule spectroscopy. However, in theses investigations the absolute concentration of the molecules has always been such small from the beginning that the measurement values of interest were determinable independently on the switching state of the molecules, i.e. even with all molecules being in their on-state.

In a method described by M. Moertelmaier et al.: “Thinning out clusters while conserving stoichiometry of labeling” in Applied Physics Letters 87, 263903 (2005), the concentration of the marker molecules emitting fluorescence light out of a measurement area is reduced in that at first all marker molecules within the measurement area are permanently inactivated by means of photobleaching so that they do no longer emit any fluorescence light. The non-bleached marker molecules which afterwards diffuse from outside the measurement area into the measurement area have, at least at the beginning, a measurement concentration which is reduced as compared to the total concentration of the bleached and non-bleached marker molecules in the measurement area to such an extent that single fluorescence microscopic techniques may be applied. An optimum measurement concentration for the respective applied technique of single molecule spectroscopy, however, is only present for an instant of time as the measurement concentration continuously increases due to the diffusion short term, whereas the measurement concentration again continuously increases due to the non-bleached marker molecules diffusing into the measurement area up to the absolute concentration of the fluorescent marker molecules remaining in sample. I.e. it is not possible by means of the known method to permanently adjust a measurement concentration of the fluorescent marker molecules in the measurement area which is optimum for determining the respective measurement value of interest. Further, data analysis in this method is complicated, as the measurement concentration also varies over the measurement area during its increase. As photobleaching is an irreversible process, this method allows for measuring a small and not necessarily representative fraction of the marker molecules only once with fixed molecules and only very few times with a slow diffusion.

A stable optimum measurement concentration may also not be achieved without further measures in that a low measurement concentration of the remaining fluorescent marker molecules is adjusted by means of photobleaching the majority of all marker molecules contained in the respective sample, as photobleaching is a irreversible process and as the concentration of the remaining fluorescent marker molecules may also decrease during determining the measurement value of interest due to other processes, like for example exciting them for the emission of fluorescence light used as the measurement signal, and as, particularly, the optimum measurement concentration for determining the measurement value may vary during the measurement. Additionally, photobleaching the majority of all marker molecules contained in the respective sample would mean a limitation to a single selection of one part of the marker molecules which is not necessarily representative for all marker molecules even with a sufficiently quick diffusion of the marker molecules.

A method of determining the location of single marker molecules for imaging a sample with high spatial resolution is known from WO 2006/127692 A2 (Hess et al.). In this method, the concentration of marker molecules which are in a fluorescent state as compared to an absolute concentration of the marker molecules in the fluorescent and in a non-fluorescent state is adjusted by means of an optical signal to such a value that the position of single marker molecules may be determined due to the fluorescent light emitted by them with a spatial resolution exceeding the diffraction barrier.

The use of fluorescent dyes which are switchable between a fluorescent and a non-fluorescent state, particularly with an optical signal, to increase the spatial resolution in imaging a sample has already previously been described in WO 2004/090617 A2.

An overview over photoactivatable fluorescent proteins which may be used as marker molecules is given by K. A. Lukyanov et al.: “Photoactivatable Fluorescent Proteins” in Nature Reviews, Molecular Cell Biology, Vol. 6, November 2005, pp. 885 ff.

A need remains for a method of determining at least one measurement value on the is basis of a plurality of single molecule events of a plurality of marker molecules of a same kind in which optimum conditions for determining the measurement value may be adjusted despite an absolute concentration of the marker molecules in a sample which is, in principle, much too high for such a determination, so that the disadvantages indicated above do not have to be accepted.

### SUMMARY OF THE INVENTION

In one aspect, the present invention provides a method of determining at least one measurement value on the basis of a plurality of single molecule events of a plurality of marker molecules of a same kind which are present in a sample, the measurement value being related to another parameter than a position and an orientation of single marker molecules of the plurality of marker molecules of the same kind. This method comprises the step of selecting the marker molecules of the same kind from a group of marker molecules, the group of marker molecules consisting of: marker molecules which have a measurable state in which a measurement signal necessary for determining the at least one measurement value is obtainable from the marker molecules and a non-measurable state in which the measurement signal necessary for determining the at least one measurement value is not obtainable from the marker molecules, and which are transferrable out of their non-measurable state into their measurable state by means of a physical signal, and marker molecules which have a measurable state in which a measurement signal necessary for determining the at least one measurement value is obtainable from the marker molecules and a non-measurable state in which the measurement signal necessary for determining the at least one measurement value is not obtainable from the marker molecules, which display a transfer rate out of their non-measurable state in their measurable state, and which are transferrable out of their measurable state into their non-measurable state by means of a physical signal. This method further comprises the steps of providing the marker molecules in the sample at such an absolute concentration that the at least one measurement value is not determinable on the basis of single molecule events of the marker molecules, if all marker molecules are in their measurable state, and of adjusting a measurement concentration of the marker molecules in the measurable state by means of applying the physical signal to the sample at such an intensity that the at least one measurement value is determinable within a defined measurement area of the sample on the basis of single molecule events of the marker molecules.

In another, more detailed aspect, the present invention provides a method of determining at least one measurement value on the basis of a plurality of single molecule events of a plurality of marker molecules of a same kind which are present in a sample. This method also comprises the step of selecting the marker molecules of the same kind from a group of marker molecules, the group of marker molecules consisting of: marker molecules which have a measurable state in which a measurement signal necessary for determining the at least one measurement value is obtainable from the marker molecules and a non-measurable state in which the measurement signal necessary for determining the at least one measurement value is not obtainable from the marker molecules, and which are transferrable out of their non-measurable state into their measurable state by means of a physical signal, and marker molecules which have a measurable state in which a measurement signal necessary for determining the at least one measurement value is obtainable from the marker molecules and a non-measurable state in which the measurement signal necessary for determining the at least one measurement value is not obtainable from the marker molecules, which display a transfer rate out of their non-measurable state in their measurable state, and which are transferrable out of their measurable state into their non-measurable state by means of a physical signal. This method further comprises the steps of providing the marker molecules in the sample at such an absolute concentration that the at least one measurement value is not determinable on the basis of single molecule events of the marker molecules, if all marker molecules are in their measurable state; of adjusting a measurement concentration of the marker molecules in the measurable state by means of applying the physical signal to the sample at such an intensity that the at least one measurement value is determinable within a defined measurement area of the sample on the basis of single molecule events of the marker molecules; of imaging the measurement area on a detector detecting the measurement signal which is not spatially resolving the measurement area; and of determining the at least one measurement value from the measurement signal detected by the detector by a method selected from a group of methods including methods of single molecule spectroscopy and methods of fluctuation analysis. In determining the at least one measurement value, the measurement signal from the marker molecules is evaluated independently on a location and an orientation of the marker molecules in the measurement area.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 shows the principle setup of a device for executing one embodiment of the method of determining a measurement value on the basis of single molecule events.

FIG. 2 indicates the principles of the method in a first case in which only a few of a is plurality of marker molecules are transferred by means of an adjustment signal out of a non-measurable state into a measurable state.

FIG. 3 depicts an inversed case as compared to FIG. 2 in which all except of a few of a plurality of marker molecules are transferred out of a measurable state into a non-measurable state by means of an adjustment signal.

FIG. 4 illustrates the dependencies of the relative number of marker molecules in the fluorescent state on the measurement signal for various switchable fluorescence dyes which may be used as marker molecules in the first case indicated in FIG. 2.

FIG. 5 depicts different spatial positions of the adjustment signal with regard to the measurement area out of which a measurement signal is received in the method of determining a measurement value on the basis of single molecule events.

FIG. 6 reports an application of the method of determining a measurement value based in single molecule events in which the number of marker molecules Rhodamin 110 (Rh110) present in a nanomolecular concentration has been determined by means of fluorescence fluctuation spectroscopy despite a high excess of other marker molecules dronpa-M159S and despite the fact that the measurement signals of dronpa-M159S and Rh110 may not be distinguished by their optical wavelength and may, thus, not be separated my means of a color filter, for example.

### DETAILED DESCRIPTION

In the method of determining a measurement value on the basis of single molecule events according to the present invention, the marker molecules, by means of a physical adjustment signal, are either transferred out of their non-measurable state into their measurable state at a fraction which is small as compared to their absolute concentration so that they are present in their measurable state at a desired measurement concentration, or transferred out of their measurable state into their non-measurable state to such an extent that they only remain in the measurable state at the desired measurement concentration. In the second case no bleaching or any other final switching-off of the marker molecules is executed. Instead, in the second case, the marker molecules are selected from a group of marker molecules which return out of their non-measurable state into their measurable state at a certain transfer rate. The measurement concentration thus results from a dynamic equilibrium between the transfer rate caused by the adjustment signal and the transfer rate at which the marker molecules return out of their non-measurable state into their measurable state. In the first case, the measurement concentration of the marker molecules can at least be readjusted in such a way that, by means of increasing the adjustment signal which transfers the marker molecules, further marker molecules are transferred out of their non-measurable state into their measurable state. In the second case, the measurement concentration of the marker molecules can at least be readjusted in such a way that, by means of reducing the adjustment signal, the transfer rate of the marker molecules out of their non-measurable state into their measurable state can be used to increase the number of marker molecules in the measurable state. In the second case, a reduction of the measurement concentration is possible by means of increasing the adjustment signal. In the first case, a permanent adjustment signal is generally required, because marker molecules leave the measurement volume or transit of out of their measurable state into their non-measurable state or into another permanently non-measurable state by means of bleaching, for example. This transit may either be spontaneous or due to a further signal. Independent on the reason for the transit, the fraction of the marker molecules in the measurement volume which are in the measurable state may be reduced by means of reducing the adjustment signal in the first case.

As a result, it is possible, and particularly preferred in both the first and the second case of the method of determining a measurement value on the basis of single molecule events based on the measurement signal received out of the measurement area to adjust the measurement concentration in the defined measurement area to a concentration value which is optimum for determining the at least one measurement value of interest. The optimum concentration value may either be characterized by a maximum signal to noise ratio or an as fast as possible determination of the measurement value at a desired accuracy.

In the method of the present invention, it is also possible to account for varying measurement conditions or for varying optimum concentration values of the measurement concentration explained above in that the measurement concentration is continuously, i.e. dynamically, readjusted based on the measurement signal received out of the measurement area.

As already indicated in the context of the explanation of the possibilities of influencing the measurement concentration in the method of the invention, a variation of the adjustment signal may be used for adjusting the measurement concentration. However, it is also possible to use a further variable signal by which the marker molecules are transferred in a direction opposite to their transfer by the adjustment signal.

In the second case of the method of the invention in which the marker molecules are selected from a group of molecules which display a transfer rate out of their non-measurable into their measurable state, the underlying transfer may be a spontaneous, i.e. a thermally induced. It may, however, also be a transfer which is induced by another signal. Actually, an additional signal only influencing this transfer rate out of the non-measurable into the measurable state of the marker molecules may be used to purposefully tune or set this transfer rate. Often this transfer rate, if not spontaneous, will be induced by a signal used for obtaining the at least one measurement signal in the method of the present invention. Such a signal, for example, may be excitation light for exciting fluorescence light from the marker molecules as the measurement signal.

As a measurement value which relates to another parameter as the location or the orientation of the marker molecules in the measurement area is determined in the method of the present invention, the method of the present invention may be executed in such a way that, when determining the at least one measurement value, the measurement signal from the marker molecules is evaluated independently on from where within the measurement area it originates or to which orientation of the marker molecules within the measurement area it belongs. Actually, the measurement area may be imaged onto a detector for the measurement signal which does not spatially resolve the measurement area.

In the method of the present invention, the measurement value is typically determined on the basis of single molecule events by a method which belongs to single molecule spectroscopy. Methods of fluctuation analysis are particular use. Even more particularly, the method of the invention is suitable for application in methods of fluctuation analysis like, for example, FCS and FIDA and in various variants of MFD.

As already indicated by means of several references to the possibility of the measurement signal being fluorescence light emitted by the marker molecules, the invention particularly relates to fluorescent marker molecules. The principles of the present invention, however, are directly applicable to other measurable marker molecules.

The measurement values, which may be determined according to the method of the invention, particularly include the following:

A lifetime of a state of the marker molecules. This may be an excited state of the marker molecules. The excited state may but does not necessarily need to be a fluorescent state out of which the marker molecules decay into another or ground state upon emitting the fluorescence light used as the measurement signal.

A transfer probability and/or transfer rate of the marker molecules into a physical state.

A variation of an absorption or emission spectrum of the marker molecules. Such variations may be due to changes of the chemical or physical surroundings of the marker molecules or a bond engaged by the marker molecules or a change in conformation of the marker molecules.

A ratio between signal strengths of the measurement signals at various fluorescent light wavelengths of the marker molecules or of marker molecule complexes. In this way, for example, a change of the emission spectrum or of the distance or bonding state of two or more molecules between which an energy transfer, like for example by means of FRET, takes place may be determined.

A signal strength or brightness of the marker molecules which may also give an indication of different chemical or physical surroundings of the marker molecules and which, for example, indicates whether certain marker molecules may more easily (than others) get out of their fluorescence state on another way than by emitting fluorescence light.

A variation in time of a measurement signal from the marker molecules, which generally refers to measurement values in the field of fluctuation analysis.

A presence probability of the marker molecules in the measurement area which is a particular measurement value in fluctuation analysis and which may, for example, be used as a measure for the diffusion or fluctuation velocity within the sample.

A presence probability of the marker molecules, particularly as compared to a presence probability of other marker molecules in the measurement area. The method of the present invention, although relating to the determination of a measurement value for marker molecules of a same kind, is not limited in so far that no other measurement values related to other marker molecules may be determined in the same measurement area. Instead, the method of the present invention is particularly suited for precisely determining relative concentrations within the measurement range.

A distribution of marker molecules over several sub-states of their measurable state which are differentiable due to the measurement signal, wherein the sub-state vary the measurement signal obtainable from the marker molecules in the measurable state.

In the method of the present invention the marker molecules may be moving in the sample as it corresponds to the principle of fluctuation analysis, wherein the measurement area is fixed relative to the sample.

Vice versa, the measurement area may be moved relative to the sample to apply methods similar to fluctuation analysis for determining measurement values with marker molecules which are fixed in the sample or to obtain measurement values for different areas of the sample.

Quite a few methods according to the invention for determining measurement values on the basis of single molecule events do not require that the measurement signal can in fact be associated with single or even certain marker molecules. Instead, particularly in fluctuation analysis, the measurement signal typically originates from a collective of marker molecules which even needs to have a certain size to provide for optimum conditions for determining the measurement value of interest. Thus, in the method of the invention, the measurement concentration is typically adjusted to such a value which is at least twice as high as the reciprocal value of the dimensions of the measurement range which, as a rule in the method of the present invention, is not spatially resolved or only spatially resolved beyond the size of the measurement range. Preferably, the measurement concentration is even adjusted at a value which is at least five times as high as the reciprocal value of the dimensions of the measurement range.

As already indicated in the context of the possibilities how to adjust the measurement concentration to an optimum concentration value, a re-transferring signal may be used in addition to the adjustment signal, which differs from the adjustment signal and by which the marker molecules are transferred back into their original state in a direction opposite to the transfer due to the adjustment signal. The measurement concentration is then dynamically adjusted by means of the ratio of the intensities of the adjustment signal and the re-transferring signal. Even if the measurement concentration is then kept constant, the individual marker molecules making up this measurement concentration change. This is a principle difference to methods in which the main fraction of the marker molecules is irreversibly bleached to enable a measurement on the basis of single molecule events. In quite a number of embodiments of the methods of the present invention, a direct association of the measurement signal to certain marker molecules, which is of essential importance in the method described in WO 2006/127692 A2, is not required.

A switching-off signal by which the marker molecules may be transferred out of their measurable state in a further permanently non-measurable state has also already been indicated in the context of the possibilities of adjusting the measurement concentration. This switching-off signal may be provided by an interrogation signal, i.e. by excitation light for fluorescent marker molecules, for example, due to a natural bleaching probability of the marker molecules.

Preferably, the adjustment signal and/or the re-transferring signal and/or the switching-off signal is a physical signal, and even more preferably an optical, acoustic or thermal signal. The term “optical signal” refers to any electro-magnetic signal. A thermal signal may even be provided by the actual temperature of the sample.

Neither the adjustment signal nor the re-transferring signal nor the switching-off signal, if present, is a signal which changes the spatial distribution of the marker molecules to adjust the desired measurement concentration. Instead, the marker molecules keeping their position in the sample are transferred between different physical states by each of the signals.

The single signals, which may be used in the method of the present invention and to which an interrogation signal exciting the marker molecules for the emission of the measurement signal belongs besides the adjusting signal, the re-transferring signal and the switching-off signal, may be provided as a pair or even in three at a time by the same physical signal. Thus, the adjustment signal which transfers the fraction of the marker molecules out of a non-fluorescent in a fluorescent state may at the same time be the interrogation signal, i.e. an excitation signal for exciting the marker molecules for the emission of fluorescence light, and act as a switching-off signal in that it finally bleaches the marker molecules into a further permanently non-measurable state. The interrogation signal and the re-transferring signal may also be one and the same signal.

It may be an advantage to apply at least one signal out of the group of the adjusting signal, the re-transferring signal, the switching-off signal and the interrogation signal to the sample with a modulation in time of its intensity. Such a procedure may, for example, serve to increase the sensitivity of the method of the present invention in determining the measurement value of interest by means of making use a correlation in time between the measurement signal and the interrogation signal. Such phase lock techniques are known as such. A variation in time of the adjustment signal and of other signals which have an influence on the measurement concentration may also be used for adjusting the optimum concentration value of the measurement concentration in that the actual influences on the measurement value are observed in a so called tracking procedure for achieving the optimum concentration value. Often a variation in time of the respective signals, however, serves the primary end of discriminating other signals from the measurement signal of interest at a detector.

Particularly, the adjustment signal but also any other signal of the group of the adjustment signal, the re-transferring signal, the switching-off signal and the interrogation signal, may be applied to the sample with a spatially structured distribution. By means of such a spatially structured distribution of the adjustment signal, for example, the measurement area may be defined in that only in this measurement area a concentration value of the marker molecules in the measurable state is adjusted at all. The measurement area may, however, also be defined by the interrogation signal, the re-transferring signal or simply by the detector for detecting the measurement signal.

In this context, it may be of particular advantage to apply one of the signals used in executing the method of the present invention in a form of a two or multiple photon interaction.

A further possibility of providing a spatial structure particularly of the adjustment signal but also of the re-transferring signal or switching-off signal is that it is applied to the sample outside the measurement area so that only those marker molecules are influences by the signal which diffuse through the area of the respective signal into the measurement area. In this way a ring or a hull of the adjustment signal may be placed around the measurement area. If the measurement signal is applied to the sample within the measurement area instead, it preferably has a constant intensity over the measurement area to keep the interpretation of the obtained measurement value easy.

To the end of increasing the measurement velocity of the method of the present invention, the marker molecules may be measured in several separated measurement areas of the sample in parallel. To this end, a detector spatially resolving the different measurement areas may be used for detection of the measurement signal.

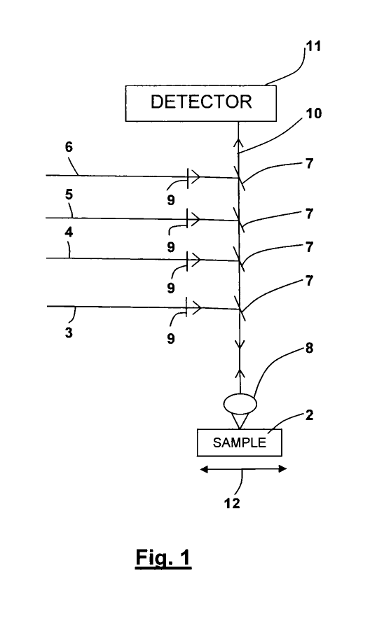

Referring now in greater detail to the drawings, FIG. 1 illustrates a device 1 which corresponds to a device which is typically used for conventional fluctuation analysis despite of the plurality of the signals 3 to 6 which may be applied to a sample 2 here. Marker molecules in the sample 2 which are not individually depicted here are illuminated in the focal area of an objective 8 by means of an interrogation signal 3. In the opposite direction, a measurement signal 10 from the marker molecules gets through the same objective 8 onto a detector 11. In quite a few cases the measurement signal will be fluorescence light which is emitted by marker molecules in the focus of the objective 8 due to an excitation by means of the interrogation signal 3. Due to a confocal arrangement of the detector 11 or of a pinhole arranged in front of it or due to the dimensions of a sample container the measurement area out of which the measurement signal 10 is registered is delimited to a small spatial area, typically to a so-called “diffraction limited” detection volume. To reduce the concentration of the marker molecules from which the measurement signal 10 is obtained to a measurement concentration which is smaller than the absolute concentration of the marker molecules and which allows for determining measurement values on the basis of single molecule events, the further signals 4 to 6 are provided. An adjustment signal 4 switches the marker molecules out of a non-fluorescent, i.e. non-measurable, state in a fluorescent, i.e. measurable, state here. Vice versa, a re-transferring signal 5 switches the marker molecules back in their original state; and a switching-off signal 6 serves for transferring the marker molecules in a further state in which they are permanently no longer fluorescent, i.e. no longer measurable. The beam paths of the signals 3 to 6 and of the measurement signals 10 are combined and separated by optical parts 7 which may, for example, be dichroitic mirrors. Additionally, phase plates 9, for example, may be arranged in each beam path to spatially modulate the intensity distribution of the respective signals within the sample. By means of a scanning unit 12 depicted by means of a double arrow, a relative movement of the sample 2 with regard to the objective 8 takes place to scan the sample 2 with the measurement area. Alternatively, a scanning unit which moves the measurement range relative to the objective 8 and the sample 2 may be arranged in the beam paths. To the end of in fact only registering the measurement signal 10 of interest with the detector, the detector may in addition to its confocal arrangement be operated with temporal resolution so that it, for example, receives the fluorescence light induced by a pulse of the interrogation signal 3 as the measurement signal 10 but no reflections of the interrogation signal 3 and also no reflected parts of the also pulsed further signals 4 to 6. The adjustment signal 4, the switching-off signal 6, the interrogation signal 3 and the re-transferring signal 5 may either be applied simultaneously or in any suitable sequence with or without overlaps. Particularly, the measurement signal or the measurement signals may also be separated by suitable color filters.

Actually, the interrogation signal 3 may completely or partially also have the function of the adjustment signal 4 or of the re-transferring signal 5 in that it not only evokes the measurement signal 10 but also transfers the marker molecules in the one or the other direction between their measurable state and their non-measurable state. In this case, it can be done without a further adjusting signal 4, re-transferring signal 5 or switching-off signal 6, if the transfer rate due to the interrogation signal 3 is sufficient for adjusting the desired measurement concentration of the marker molecules in the measurement range. In the simplest case, only one interrogation signal 3 is required which fulfils all functions of the signals 3 to 6 which are separately depicted in FIG. 1. Often, however, at least one further signal is required besides the interrogation signal 3, which has another wavelength than the interrogation signal 3. Further, all signals may be different with regard to their wavelengths.

The apparatus depicted in FIG. 1 allows for measuring reaction kinetic constants, internal transfer rates, diffusion and fluctuation velocities, bonding affinities and the statistical distribution function of lifetime, brightness and other molecule parameters by means of the measurement signal 10 on the basis of single molecule events. If the detector 11 in of the apparatus of FIG. 1 has several detection channels allowing to distinguish between different spectral ranges of the light detected as the measurement signal 10 FRET-efficiencies may additionally be measured, for example.

The indicated scanning unit 12 also allows for executing fluctuation measurements at static samples, i.e. at samples with fixed marker molecules, or to observe differences in the measurement signal 10 out of different areas of the sample 2. The apparatus 1 may also be upgraded in that the marker molecules are measured in several measurement areas in parallel, i.e. simultaneously. To this end, several separate detectors 11 or one spatially divided detector with individual separated detection areas may be used for the individual measurement areas. The setup of the apparatus 1 may then correspond to a spatial embodiment of a so-called video-microscope. It is, however, important that the temporal resolution of the detector is sufficient to execute the method of the present invention, i.e. of determining at least one measurement value on the basis of a plurality of single molecule events. From the present state of the art, EMCCD and CMOS cameras, the latter ones in general combined with a image intensifier, are suitable.

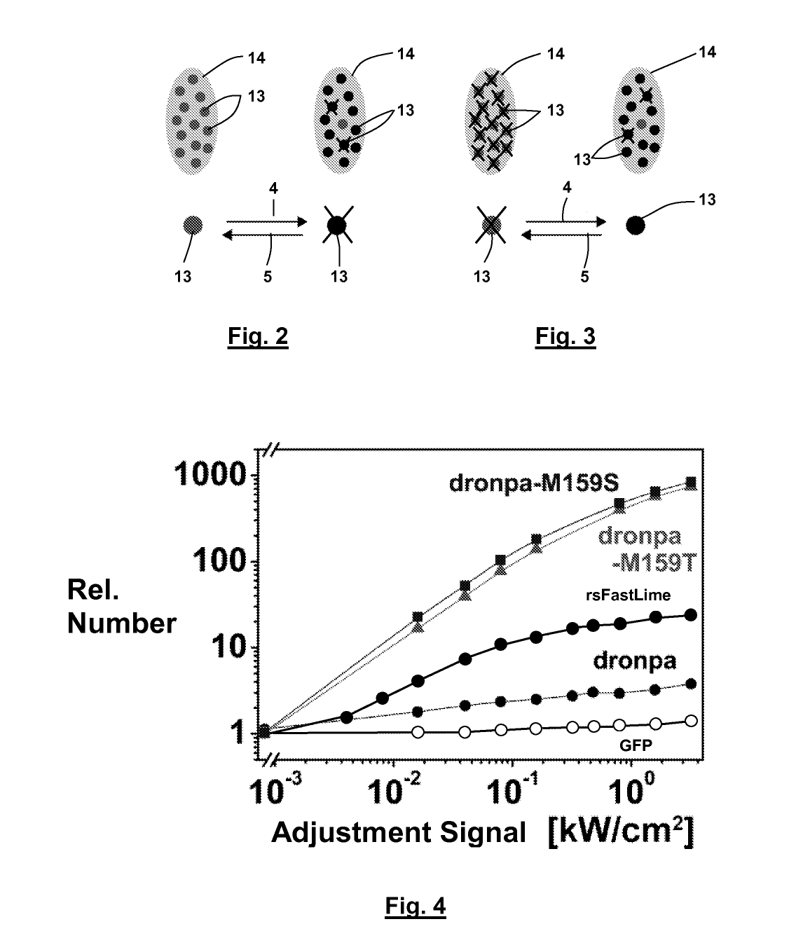

FIG. 2 indicates the effect of the adjustment signal 4 on the marker molecules 13 in the measurement range 14. On the left hand side of FIG. 2 all marker molecules are in a non-measurable state in which they do not emit a measurement signal 10 in response to the interrogation signal 3 according to FIG. 1. Due to the adjustment signal 4, a small fraction of the marker molecules 13 is transferred in a measureable state, which is indicated on the right hand side of FIG. 2 in that two marker molecules 13 are marked with an “x”. The re-transferring signal 5 has an opposite effect, i.e. it transfers the marker molecules 13 out of their measurable state in their non-measurable state. Alternatively or in addition, a switching-off signal 6 according to FIG. 1 may be used which transfers the marker molecules 13 into a permanently non-measurable state (not depicted). The transfer rates due to the adjustment signal 4 and the re-transferring signal 5 as well as due to the switching-off signal 6 (if applied) together with all further transfer rates, induced by other signals or spontaneous, define the fraction of the marker molecules 13 which are in the measurable state. This fraction may be adjusted by the intensities of the signals 4 and 5 in such a way that an optimum measurement concentration of the marker molecules 13 for determining a particular measurement value on the basis of single molecule events is present in the measurable state.

FIG. 3 depicts another case of the method of the invention in which the marker molecules 13 are transferred out of their original measurable state (on the left hand side of FIG. 3) within the measurement range 14 into their non-measurable state (on the right hand side of FIG. 3) by means of the adjustment signal 4 to such an extent that only very few marker molecules 13 remain in the measurable state. With this small fraction of the measurable marker molecules 13, the desired measurement concentration for determining the measurement value of interest on the basis of single molecule events is achieved. In the opposite direction, the re-transferring signal 5 transfers the marker molecules 13 back into their measurable state. The re-transferring signal 5 may be unnecessary, if, for example, a spontaneous transfer of the marker molecules 13 or of their non-measurable state into their measurable state occurs at a relevant transfer rate.

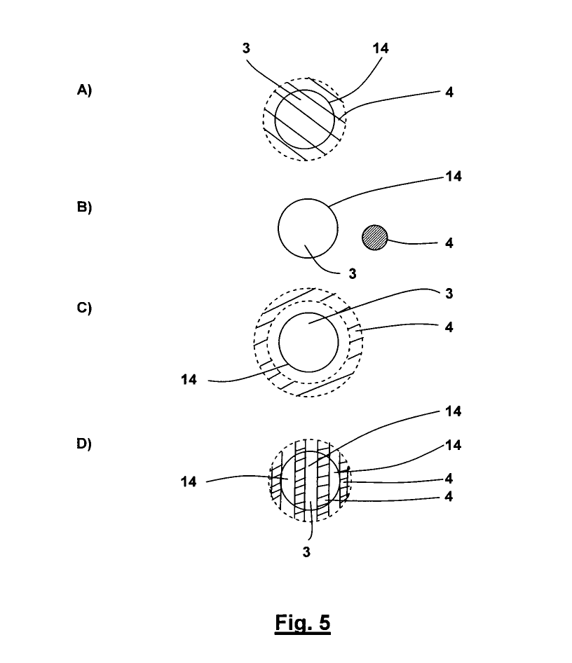

For several switchable fluorescence dyes generally known in the art, FIG. 4 depicts their fraction or relative number in their measurable, i.e. fluorescent state in dependency on the intensity of the adjustment signal 4 according to FIG. 2, which transfers them into their measurable state. The data according to FIG. 4 are based on an adjustment signal in form of UV-light at a wavelength of 405 nm. The interrogation signal 3 according to FIG. 1 is blue light at a wavelength of 488 nm here. The relative number of the measurable marker molecules has been determined by means of fluorescence fluctuation spectroscopy according to the FIDA method registering the fluorescent light as the measurement signal 10 with a point detector.

FIG. 5A illustrates a case in which the area of the adjustment signal 4 covers the total measurement area 14 which is covered by the interrogation signal 3 and even exceeds this measurement area. The adjustment signal 4 thus directly determines the measurement concentration of the marker molecules which are in their measurable state within the measurement area 14.

FIG. 5B illustrates a case in which the adjustment signal 4 is applied outside the measurement area 14 in which the measurement signal is generated by means of the interrogation signal 3. In this case, the adjustment signal 4 only has an indirect influence on the measurement concentration of the marker molecules which are in their measurable state in the measurement area 14 which depends on the diffusion of the marker molecules.

FIG. 5C illustrates a case in which by means of a diffractive element, a so-called phase mask, in the beam of the adjustment signal 4, a ring of the adjustment signal 4 is placed around the measurement area 14. With the proviso that the marker molecules move in a suitable way, for example due to diffusion, the measurement can thus be made in an area in which no adjustment signal 4 is applied to the sample. A separation of the interrogation signal 3 and of measurement signal generated by the adjustment signal 4 may also be effected by an offset in time between the adjustment signal 4 and the interrogation signal 3. I.e. the actual measurement only takes place some time after the adjustment of the desired measurement concentration of the marker molecules in the measurement area 14.

In FIG. 5D a spatial modulation of the adjustment signal 4 is illustrated. In this way, the area of the interrogation signal 3 can, for example, be divided up in several discrete measurement areas 14, or the effect of diffusion and kinetics may be separated. In combination with one spatially resolving detector or several detectors, this arrangement can also be used for simultaneously measuring several measurement areas 14.

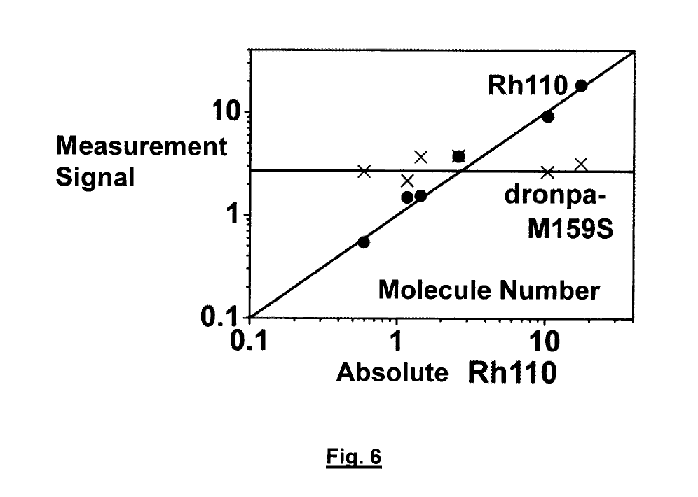

In a particular example whose results are depicted in FIG. 6, the concentration of the marker molecule Rhodamin110 (Rh110) has been measured in the presence of a high excess of another marker molecule dronpa-M159S whose measurement signal may, for example, not be separated from that one of the marker molecule Rh110 by means of color filters. The measurement concentration of the dronpa-molecules has been adjusted to the same order as the concentration of the Rhodamin-molecules in that only a small fraction of the absolute concentration of the dronpa-molecules have been switched in their measurable state. Thus, a variation of the Rhodamin concentration at a constant but much higher absolute dronpa concentration could be resolved by means of fluorescence fluctuation analysis. The measurement simulates the measurement conditions with bonding events of low affinity, for example.

The method of the invention may also be used for observing protein-protein interactions, wherein one protein is marked with a FRET-donor and one protein is marked with a FRET-acceptor. The interrogation light excites the donor. If a bond is formed, there is, however, a certain probability that the acceptor instead of the donor emits fluorescent light as due to the bond an energy transfer from the donor onto the acceptor may take place. The probability of the energy transfer is a measure of the distance and the relative orientation of the donor and the acceptor. In that, by means of the method of the present invention, the donor may be switched to a suitable measurement concentration in each diffraction limited point of a sample used as a measurement area, a histogram of the distances may be determined in that in each such point very often always exactly one FRET pair (or a single donor/acceptor) is interrogated and in that either its lifetime or the relative fluorescence of acceptor and donor are determined.

Many variations and modifications may be made to the preferred embodiments of the invention without departing substantially from the spirit and principles of the invention. All such modifications and variations are intended to be included herein within the scope of the present invention, as defined by the following claims.

We claim:

1. A method of determining at least one measurement value on the basis of a plurality of single molecule events of a plurality of marker molecules of a same kind which are present in a sample, the measurement value being related to another parameter than a position and an orientation of single marker molecules of the plurality of marker molecules of the same kind, the method comprising the steps of:
selecting the marker molecules of the same kind from a group of marker molecules, the group of marker molecules consisting of:
marker molecules
which have a measurable state in which a measurement signal necessary for determining the at least one measurement value is obtainable from the marker molecules and a non-measurable state in which the measurement signal necessary for determining the at least one measurement value is not obtainable from the marker molecules, and
which are transferrable out of their non-measurable state into their measurable state by means of a physical signal, and
marker molecules
which have a measurable state in which a measurement signal necessary for determining the at least one measurement value is obtainable from the marker molecules and a non-measurable state in which the measurement signal necessary for determining the at least one measurement value is not obtainable from the marker molecules,
which display a transfer rate out of their non-measurable state in their measurable state, and
which are transferrable out of their measurable state into their non-measurable state by means of a physical signal,
providing the marker molecules in the sample at such an absolute concentration that the at least one measurement value is not determinable on the basis of single molecule events of the marker molecules, if all marker molecules are in their measurable state, and
adjusting a measurement concentration of the marker molecules in the measurable state by means of applying the physical signal to the sample at such an intensity that the at least one measurement value is determinable within a defined measurement area of the sample on the basis of single molecule events of the marker molecules.

2. The method of claim 1, and comprising the further step of fine-tuning the measurement concentration of the marker molecules to an optimum concentration for determining the at least one measurement value in the defined measurement area using the measurement signal obtained out of the measurement area as a feedback signal.

3. The method of claim 2, wherein the measurement concentration of the marker molecules is continuously fine-tuned to the present optimum concentration for determining the at least one measurement value in the defined measurement area.

4. The method of claim 2, wherein the measurement concentration is fine-tuned by means of at least one signal selected from the physical signal and a further signal by which the marker molecules are transferred between their measurable and their non-measurable states in a direction opposite to their transfer by the physical signal.

5. The method of claim 1, wherein the marker molecules displaying the transfer rate out of their non-measurable state in their measurable state are selected from a subgroup of marker molecules, the subgroup of marker molecules consisting of marker molecules displaying the transfer rate out of their non-measurable state in their measurable state as a spontaneous transfer rate or due to a signal used for obtaining the measurement signal from the marker molecules.

6. The method of claim 1, wherein, in determining the at least one measurement value, the measurement signal from the marker molecules is evaluated independently on a location of the marker molecules in the measurement area.

7. The method of claim 1, wherein, in determining the at least one measurement value, the measurement signal from the marker molecules is evaluated independently on a orientation of the marker molecules in the measurement area.

8. The method of claim 1, wherein the measurement area is imaged on a detector detecting the measurement signal which is not spatially resolving the measurement area.

9. The method of claim 1, wherein the at least one measurement value is determined by a method of single molecule spectroscopy.

10. The method of claim 1, wherein the at least one measurement value is determined by a method of fluctuation analysis.

11. The method of claim 1, wherein the measurement signal is fluorescence light emitted by the marker molecules.

12. The method of claim 1, wherein the at least one measurement value is selected from a group of measurement values, the group of measurement values consisting of:
a lifetime of a physical state of the marker molecules,
a transfer probability of the marker molecules in a physical state,
a transfer rate of the marker molecules in a physical state,
a variation of an absorption spectrum of the marker molecules,
a variation of an emission spectrum of the marker molecules,
a ratio of signal powers of the measurement signal at a plurality of fluorescence light wave lengths of the marker molecules,
a signal strength of the marker molecules,
a brightness of the marker molecules,
a variation in time of components of the measurement signal from the marker molecules,
a length of stay of the marker molecules in the measurement area,
a presence probability of the marker molecules in the measurement area,
a presence probability of the marker molecules in the measurement area as compared to the present probability of other marker molecules in the measurement area,
a distribution of the marker molecules over a plurality of sub-states of their measurable state, the sub-states being differentiable by means of the measurement signal.

13. The method of claim 1, wherein the marker molecules are mobile within the sample, whereas the measurement area is fixed with regard to the sample.

14. The method of claim 1, wherein the measurement area is moved with regard to the sample.

15. The method of claim 1, wherein the measurement concentration is adjusted to a value which is at least twice as high as the reciprocal value of the dimensions of the measurement range.

16. The method of claim 1, wherein the marker molecules are transferred back into their original state out of which they have been transferred by the physical signal by means of a re-transferring signal which differs from the physical signal.

17. The method of claim 1, wherein the marker molecules are transferred out of their measurable state into a further permanently non-measurable state by means of a switching off signal.

18. The method of claim 1, wherein every signal applied to the sample is a selected from a group of signals consisting of optical, acoustic and thermal signals.

19. The method of claim 16, wherein at least two signals of the physical signal, the re-transferring signal, and an interrogation signal by which the marker molecules are exited for providing the measurement signal are provided by the same physical signal.

20. The method of claim 16, wherein at least one signal of the physical signal, the re-transferring signal, and an interrogation signal by which the marker molecules are exited for providing the measurement signal is applied with a modulation in time of its signal intensity.

21. The method of claim 16, wherein at least one signal of the physical signal, the re-transferring signal, and an interrogation signal by which the marker molecules are exited for providing the measurement signal is applied with a structured spatial distribution over the sample.

22. The method of claim 17, wherein at least two signals of the physical signal, the switching off signal, and an interrogation signal by which the marker molecules are exited for providing the measurement signal are provided by the same physical signal.

23. The method of claim 17, wherein at least one signal of the physical signal, the switching off signal, and an interrogation signal by which the marker molecules are exited for providing the measurement signal is applied with a modulation in time of its signal intensity.

24. The method of claim 17, wherein at least one signal of the physical signal, the switching off signal, and an interrogation signal by which the marker molecules are exited for providing the measurement signal is applied with a structured spatial distribution over the sample.

25. The method of claim 21, wherein a structured spatial distribution of the physical signal defines the measurement area.

26. The method of claim 24, wherein a structured spatial distribution of the physical signal defines the measurement area.

27. The method of claim 1, wherein the physical signal is applied to the sample outside the measurement area.

28. The method of claim 1, wherein the physical signal is applied to the sample with a constant intensity over the measurement area.

29. The method of claim 1, wherein the marker molecules in the sample are simultaneously measured in a plurality of separate measurement areas.

30. A method of determining at least one measurement value on the basis of a plurality of single molecule events of a plurality of marker molecules of a same kind which are present in a sample, the method comprising the steps of:
selecting the marker molecules of the same kind from a group of marker molecules, the group of marker molecules consisting of:
marker molecules
which have a measurable state in which a measurement signal necessary for determining the at least one measurement value is obtainable from the marker molecules and a non-measurable state in which the measurement signal necessary for determining the at least one measurement value is not obtainable from the marker molecules, and
which are transferrable out of their non-measurable state into their
marker molecules
which have a measurable state in which a measurement signal necessary for determining the at least one measurement value is obtainable from the marker molecules and a non-measurable state in which the measurement signal necessary for determining the at least one measurement value is not obtainable from the marker molecules,
which display a transfer rate out of their non-measurable state in their measurable state, and
which are transferrable out of their measurable state into their non-measurable state by means of a physical signal,
providing the marker molecules in the sample at such an absolute concentration that the at least one measurement value is not determinable on the basis of single molecule events of the marker molecules, if all marker molecules are in their measurable state,
adjusting a measurement concentration of the marker molecules in the measurable state by means of applying the physical signal to the sample at such an intensity that the at least one measurement value is determinable within a defined measurement area of the sample on the basis of single molecule events of the marker molecules,
imaging the measurement area on a detector detecting the measurement signal which is not spatially resolving the measurement area, and
determining the at least one measurement value from the measurement signal detected by the detector by a method selected from a group of methods including methods of single molecule spectroscopy and methods of fluctuation analysis,
wherein, in determining the at least one measurement value, the measurement signal from the marker molecules is evaluated independently on a location and an orientation of the marker molecules in the measurement area.
